(19) United States
(12) Patent Application Publication
(10) Pub. No.: US 2012/0330710 A1
(43) Pub. Date: Dec. 27, 2012

(54) METHODS AND SYSTEMS FOR INTEGRATING TIMING AND LOCATION INTO APPOINTMENT SCHEDULES

(75) Inventors: David Hauser, Oakland, CA (US); Gaurav Chawla, Foster City, CA (US); Maggie (Minzhi) Hu, Cupertino, CA (US); Akhilesh Gupta, San Francisco, CA (US); Yudi Nagata, San Francisco, CA (US)

(73) Assignee: SALESFORCE.COM, INC., San Francisco, CA (US)

(21) Appl. No.: 13/211,569

(22) Filed: Aug. 17, 2011

Related U.S. Application Data
(60) Provisional application No. 61/501,601, filed on Jun. 27, 2011.

(51) Int. Cl. G06Q 10/00

(52) U.S. Cl. 705/7.15; 705/7.13

(57) ABSTRACT

A scheduler integrates worker time and location into customer appointment schedules by obtaining the status of workers' meetings with customers and forwarding updated schedule messages to waiting customers if the worker is late for an appointment due to traffic or unexpected delays at the previous customer meeting. The waiting customers receiving the updated schedules can respond by accepting the updated schedule, adjusting the meeting time or cancelling the appointment. The scheduler eliminates the need for customers to have to wait for long periods of time for service workers to arrive and allows them to adjust the meeting appointment based upon their schedules.

### CLAIM OF PRIORITY

This application claims the benefit of U.S. Provisional Patent Application No. 61/501,601 entitled, SYSTEMS AND METHODS FOR INTEGRATING TIMING AND LOCATION, by Hauser, et al., filed Jun. 27, 2011 (Attorney Docket No. 640PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to methods and system for integrating timing and location information with various mobile devices having different operating systems.

### BACKGROUND

A problem with current service providers is the inability to schedule meetings with customers within a reasonable time window. Frequently, customers will need service at their house and they will call a company to schedule a service meeting at their house. The customer who is scheduled to meet with the worker will often be asked to wait at a specified location for a period of four hours, i.e., a four hour meeting window. This makes the worker's exact time of arrival ambiguous, thereby impacting the customer's schedule and ability to work on other tasks.

What is needed is a system and method for providing more accurate timing for scheduled meetings.

### BRIEF SUMMARY

In an embodiment, the present invention includes a scheduler that communicates with workers through mobile device such as smart phones and customers through any electronic communication devices available to the customers. The scheduler can be used to organize appointments for the workers and provide information such as appointment directions, times and locations. The scheduler can assign each worker a series of clients to meet with during a work day. In another embodiment, the scheduler can assign a first meeting to each worker and then assign workers to other subsequent clients as the workers complete their work and become available.

As the workers meet with the customers and perform work, the scheduler can obtain the status of work for the customers and forwarding updated schedule messages to waiting customers if the worker is late. The scheduler can receive information indicating that a worker is going to be late due to unexpected delays in completing a task for a customer. The worker can input the additional amount of time needed and transmit this information from a mobile device to the scheduler. The scheduler can also monitor traffic and other potential delays such as a low gas tank in the worker's vehicle. Based upon all delay factors, the scheduler can predict the identify appointments that will be late and the estimated time delay.

When a meeting appointment is going to be late, the scheduler can transmit an updated schedule to the waiting customer. The customer can respond to the updated schedule in various different ways. The customer may accept the updated appointment, adjust the appointment meeting time or cancelling the appointment without rescheduling. This customer response can be transmitted to the scheduler and the mobile device of the worker. The worker can then go to the next meeting at the rescheduled time or cancel the meeting depending upon the customer's instructions. The scheduler eliminates the need for customers to have to wait for long periods of time for service workers to arrive and allows them to adjust the meeting appointment based upon their schedules.

While one or more implementations and techniques are described with reference to an embodiment of the mobile test framework in an online demand service environment is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a block diagram of an embodiment of a customer scheduling platform;

FIG. 2 illustrates a flowchart of the scheduling of customer meetings with workers;

FIGS. 3-5 illustrate examples of GUIs that show the worker's schedule, appointment information and time adjustments;

FIGS. 6-7 illustrates customer GUIs that inform the customer of delays and allow the customer to reschedule or cancel an appointment;

FIG. 8 illustrates a flowchart of a scheduler assigning workers to clients as they become available;

FIG. 9 illustrates a block diagram of an example of an environment wherein an on-demand database service might be used; and

FIG. 10 illustrates a block diagram of an embodiment of elements of FIG. 9 and various possible interconnections between these elements.

### DETAILED DESCRIPTION

Systems and methods are provided for a mobile device testing framework in an online demand service environment.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing mobile device testing framework in an online demand service environment will be described with reference to example embodiments.

The following detailed description will first describe setting up data for the application in accordance with aspects and embodiments.

The SaaS Mobile Test Framework provides end-to-end automated testing of critical mobile application functionality. Test Framework can perform various functions such as creating a new record on an actual device, propagating that new record over the carrier network to Universal Data Access Server (UDAS), verifying the new record creation in the SaaS database using the SaaS Application Programming Interface (API) and other functions.

The invention is directed towards a system and method for integrating timing and location into a customer appointment service. In an embodiment, mobile devices such as iOS or Android devices run a software application used by “on-the-go” workers who have multiple appointments scheduled though out the day with one or more customers in different locations. A software application can be integrated with the worker's mobile device calendar, address and contact information of the customer, geo-location service and a navigation service. The software application provides a dynamic, real-time or near real-time way to efficiently coordinate a meeting between a worker and a customer minimizing wasted waiting time. A customer can be informed via telephone call, SMS, email, or other notifications of a more specific time or arrival for the worker, thereby enabling the customer to plan accordingly.

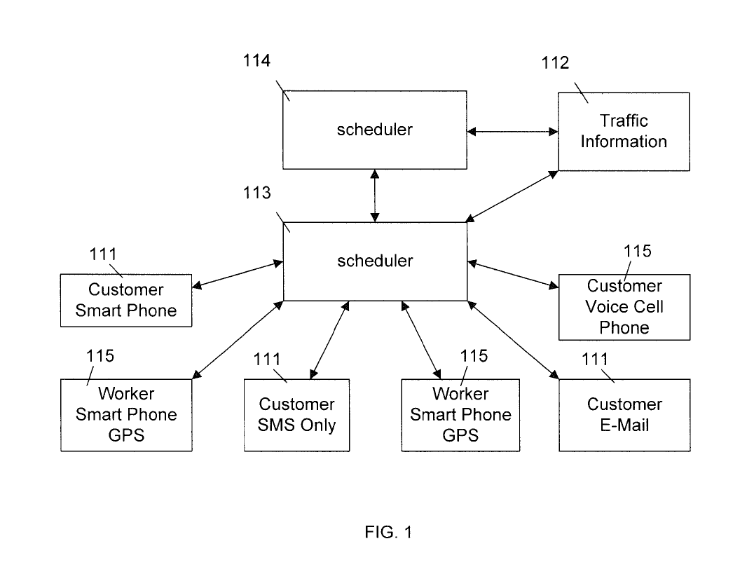

With reference to FIG. 1, block diagram of an embodiment of the system components is illustrated. Customers 111 can communicate with a company through a network to a scheduler 113 that schedules appointments based upon the company resources which can be one or more workers 115. The customers 111 can provide desired meeting time, meeting location and a description of the work required. The scheduler 113 can schedule meetings in various different ways. In an embodiment, the scheduler 113 can schedule meetings sequential for each worker 115 based upon the locations of the customers 111 and the expected time to complete the work. Alternatively, the scheduler 113 can schedule meetings based upon the availability of the workers 115. For example, the scheduler 113 may assign each of the workers 115 a first customer meeting and then assign the subsequent meetings to the first available workers based upon estimated arrival times. The scheduler 113 can provide estimated meeting times as well as estimated transportation times based upon detected locations, traffic, updates from the workers 115, etc. In an embodiment, the scheduler 113 can obtain current or predicted traffic information from an external traffic information source 112 that can be used to predict the travel times of the workers 115. The communications between the customers 111, scheduler 113 and workers 115 can be through wired and wireless networks including the Internet and cellular networks. In an embodiment, the communications can be through software applications that provide graphical user interfaces to computers or mobile electronic devices such as mobile phones.

In different embodiments, the system may include multiple schedulers 113, 114 that can operate in various different modes. For example, the schedulers 113, 114 can operate in primary operation and back up operation capacities so that if a scheduler 113 fails, the backup scheduler 114 can maintain operations. The schedules 113, 114 can be in separate locations so that if the main scheduler 113 is in a fire or is without power, the backup scheduler 114 can be used.

The inventive system can be compatible with various different types of mobile devices and the communications with the customers 111 may depend upon the type of mobile device that they are using. If the customer 111 has a smart phone, an application may be downloaded and the customer 111 may be able to access information about the scheduled work from the scheduler 113. The scheduler 113 can also transmit information that is displayed on the smart phone in a GUI and the customer 111 can respond through the GUI. If the customer 111 has a phone that allows for text or SMS messaging, the scheduler 113 can transmit information to the customer 111 through SMS messaging and the customer 111 can respond with SMS messages that can be interpreted by the scheduler 113. If the customer 111 has a voice only phone, the scheduler 113 can leave audio messages and the customer 111 can respond with voice instructions that are interpreted by the scheduler 113. In some cases, the customer 111 may wish to have all communications via e-mail. The scheduler 113 can transmit e-mail messages and the customer 111 can respond with reply e-mail messages back to the scheduler 113.

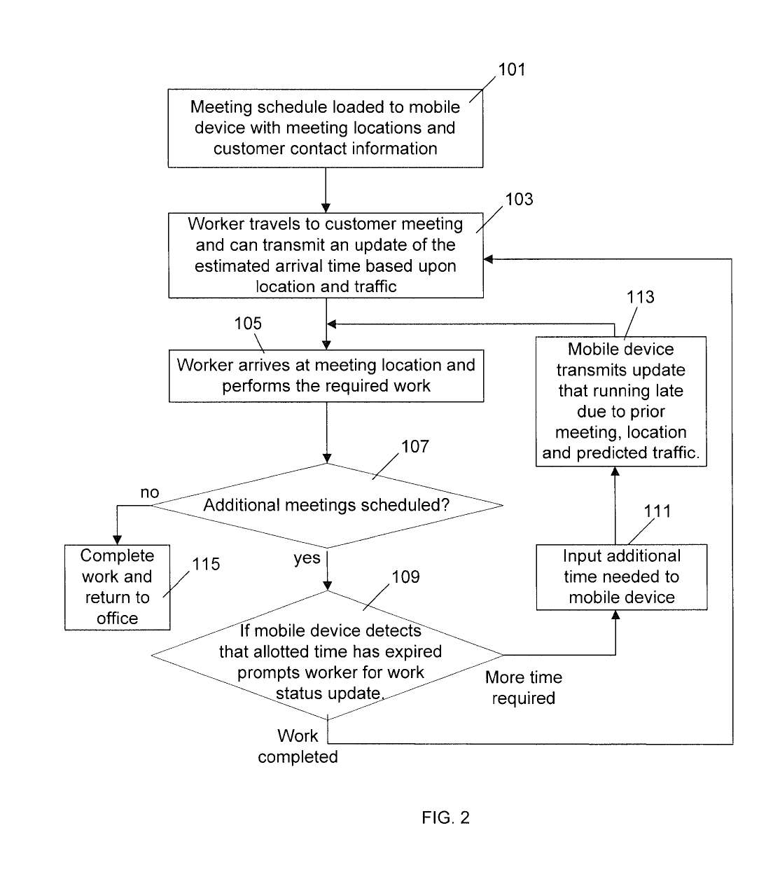

With reference to FIG. 2, a flowchart of an embodiment of the scheduling process is illustrated. Meetings for a day can be scheduled for one or more workers and the schedule can be down loaded to the mobile device along with meeting location and customer contact information 101. The meetings can be organized based upon most efficient route, customer availability or any other organizational process. The worker reviews the day's schedule and travels to the first customer meeting. The system can detect current traffic conditions and predict an estimated time of arrival. If the worker is running late, the mobile device can transmit a message to the first customer with an updated estimated time of arrival 103.

The worker arrives at the first customer and process to perform the required work 105. The mobile device can determine that the worker is at the first customer meeting location based upon a GPS location signal or WiFi address that corresponds to the meeting location of the first customer. The mobile device can also determine if there are any additional meetings scheduled 107. If there are additional meetings, the mobile device can monitor the worker's progress. If the work is completed on or before the expiration of the allotted work time, the worker travels to the next customer meeting location and can transmit an update of the estimated arrival time based upon current location and traffic 103.

If the worker is at the customer location and allotted work time has expired, the mobile device can then prompt the worker for a work status update 109. If additional time is required the worker can input the additional time needed 111 and the mobile device can transmit an update to the next customer indicating the revised estimated arrival time based upon additional time needed, next meeting location and predicted traffic. The worker can complete the work for the customer and the described process will be repeated when the worker arrives at the next meeting location 105.

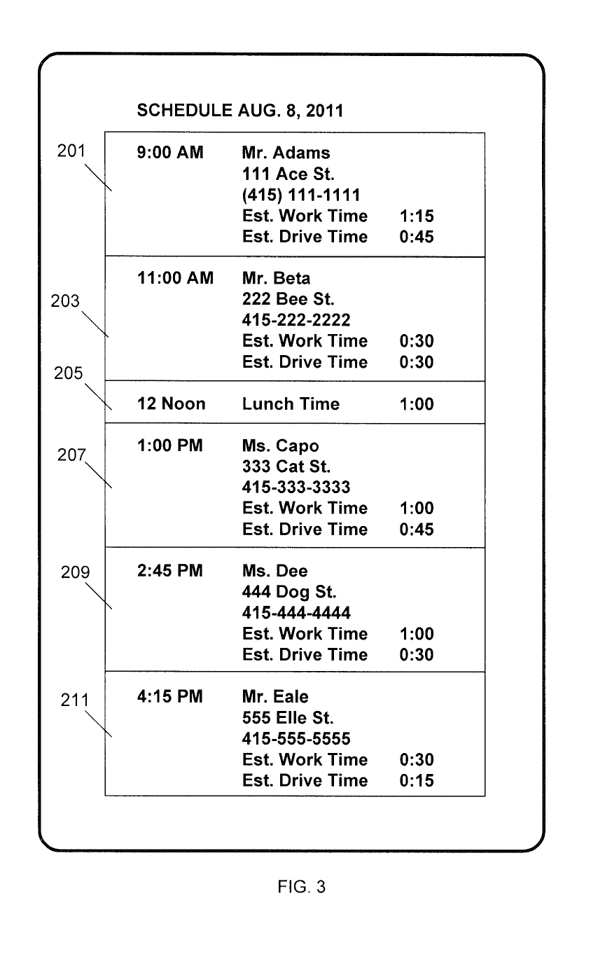

FIG. 3 illustrates an embodiment of a user interface work schedule that is downloaded to the mobile device of the worker. In this example, the worker is scheduled for a 9:00 AM meeting with Mr. Adams with an address of 111 Ace St. 201. The city and state can be optionally provided. The estimated work time is specified as 1 hour and 15 minutes and the estimated drive time to this location is 45 minutes. The next appointment is at 11:00 AM with Mr. Beta at 222 Bee St. 203. The estimated work time is 30 minutes and the estimated drive time to this location is 30 minutes. The schedule includes a lunch break 205 and three additional afternoon appointments 207, 209, 211. In other embodiments, any other means for displaying a schedule of appointments or meetings can be provided.

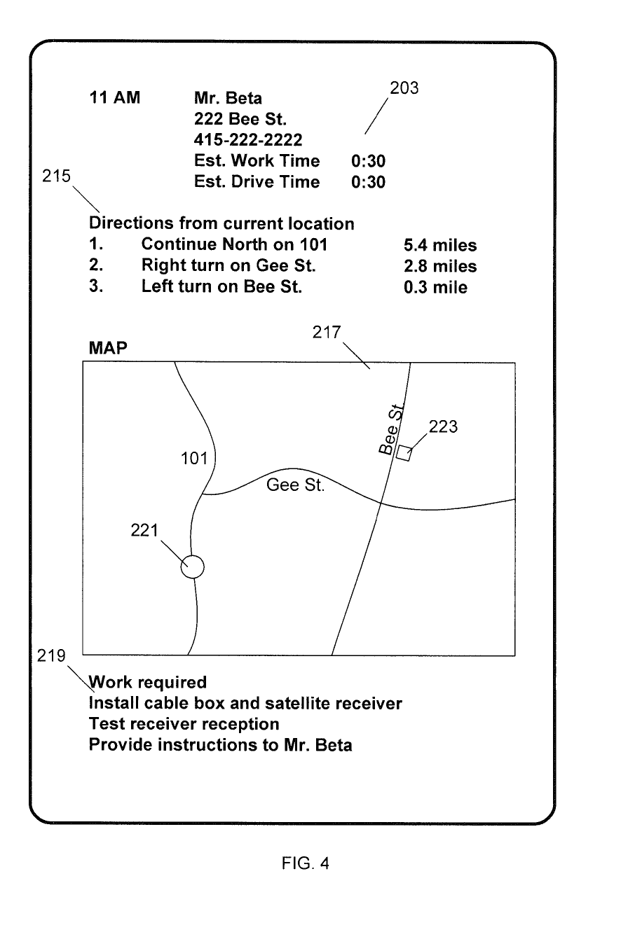

In an embodiment, the user interface can provide additional information about each meeting. With reference to FIG. 4, additional information about the second meeting with Mr. Beta is illustrated. In this example, the schedule information is listed 203 as well as written directions from the current location 215, map 217 and work description 219. The map 217 may include an icon for the worker's vehicle 221, street names and an icon for the destination 223.

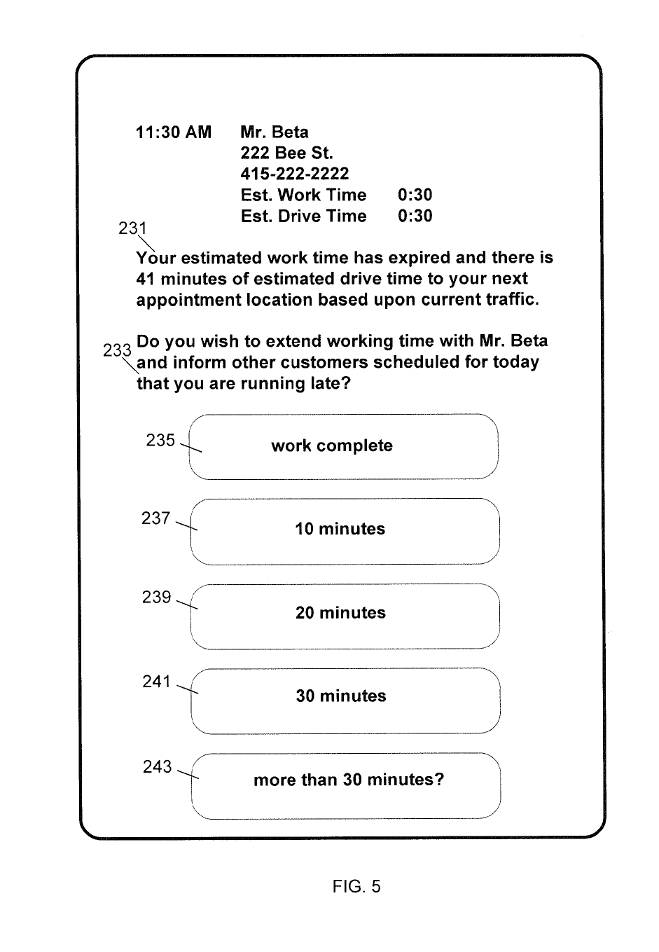

As discussed above with reference to FIG. 2, in an embodiment the system can monitor the progress of the worker. If the time required to complete the job exceeds the estimated work time, the system can prompt the worker. With reference to FIG. 5, the system can display a message indicating that the estimated work time has expired and may also provide the traffic information 231. The system can then ask the worker if more working time is needed and if an arrival delay update should be transmitted to all other customers scheduled for the day 233. In this example, the worker can respond by indicating that the work is complete 235 so only a traffic update is needed. Alternatively, the additional time required can be input. The additional time can be input as 10 minutes 237, 20 minutes 239, 30 minutes 241 or more than 30 minutes 243. The worker can respond with any of these inputs by simply touching the appropriate button on the worker's mobile device.

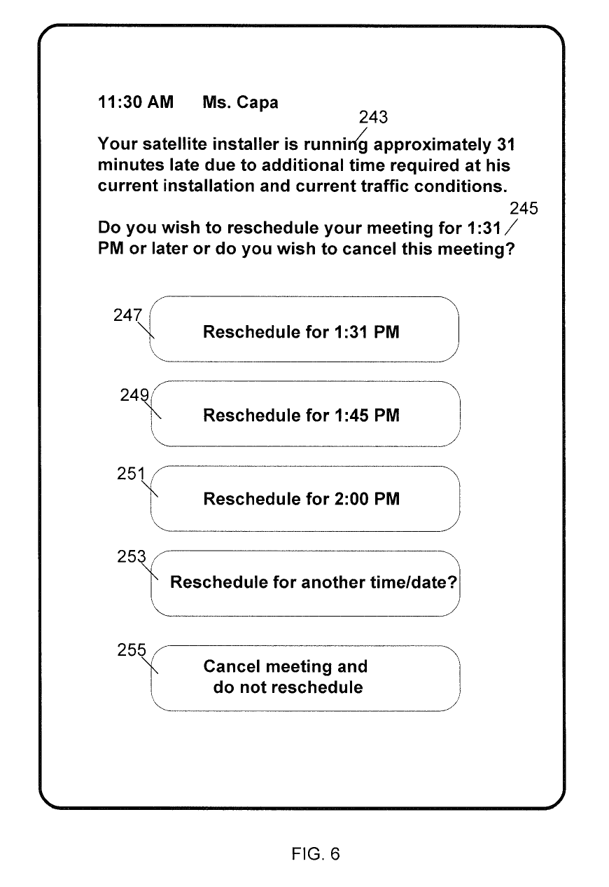

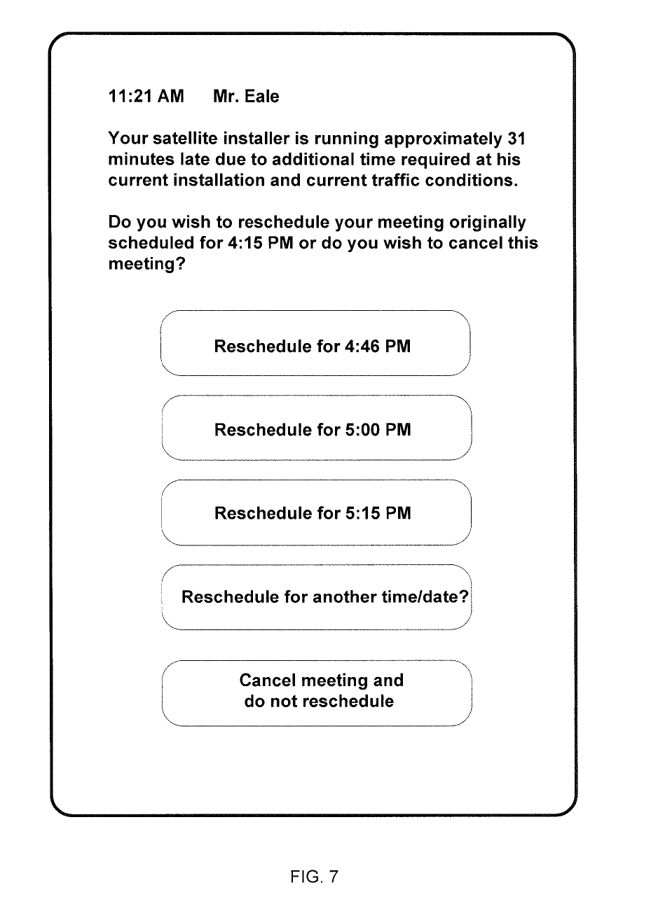

If the worker presses the 20 minute button 239, the system can transit an ETA update message to each of the mobile devices for the subsequent meetings. With reference to FIG. 6, in an embodiment, a message can be transmitted informing the customers of the delay and can include an explanation of the delay 243. The system can then ask the customer if he or she would like to reschedule or cancel the meeting 245. The user interface can include buttons for rescheduling the meeting to 1:31 PM 247, 1:45 PM 249, 2:00 PM 251, Reschedule for another time/date 253 or cancel meeting and do not reschedule 255. With reference to FIG. 7, a similar delay message can be transmitted to other mobile devices for all other subsequent scheduled meetings with the reschedule times adjusted based upon the work and traffic delays.

If the customer reschedules, the worker is instructed to arrive at the rescheduled time. In some cases, the rescheduled time may allow enough time for the worker to perform work for another customer. In an embodiment, the scheduler can determine that there is sufficient time for another scheduled customer and transmit an offer for expedited service. If the customer accepts the expedited service, the worker is directed to the new customer in order to finish the work prior to the rescheduled meeting.

The inventive system has been described as being used with dedicated applications loaded on portable electronic devices having internet service. However, in other embodiments, the system can be used with purely cellular systems through text messaging or by automated phone calls to the phone numbers of the customers. The customers may be able to respond through voice recognition systems or through reply text messaging rather than pressing buttons on an application GUI.

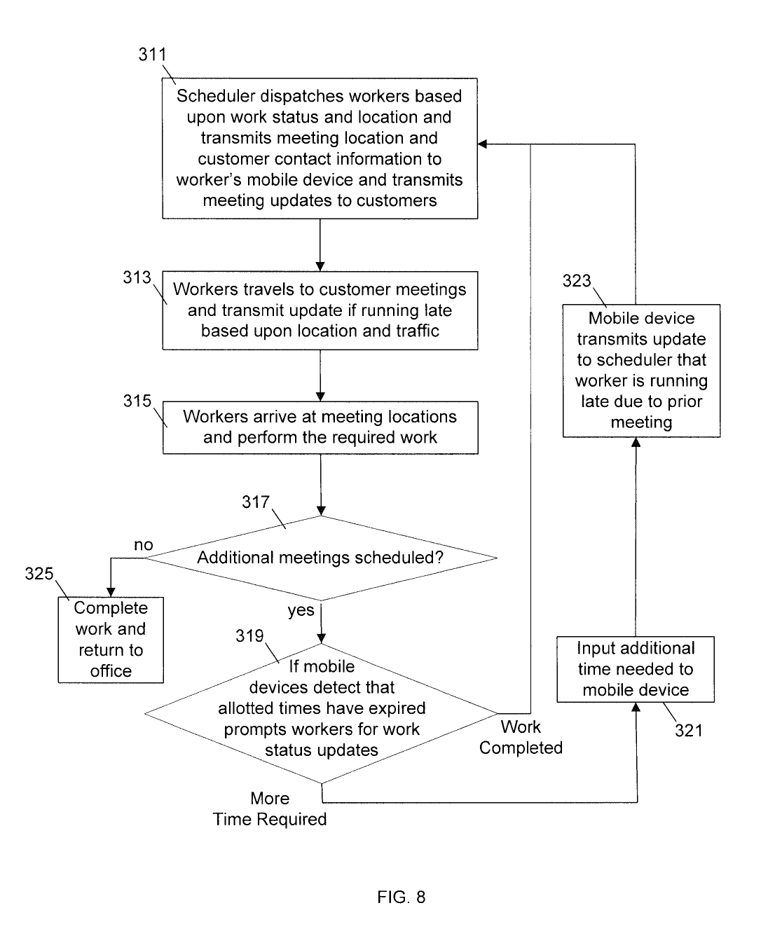

With reference to FIG. 8, as discussed above, in an embodiment, the scheduler can dispatch multiple workers to the customers based upon the work status and location relative to the customers. Based upon the locations of the workers, work status and traffic, the scheduler can transmit meeting status updates to customers 311. The workers can travel to the customer meetings and transmit updates to the scheduler or customer based upon current location and traffic 313. The workers can arrive at meetings and perform the require work 315. If there are additional meetings the mobile devices can detect the allotted times and prompt the workers if the allotted time has expired 319. If the work is completed before the allotted time has expired, the scheduler can dispatch the worker to the next job 311.

In this embodiment, the scheduler may perform a calculation to determine the most efficient worker to send to the next customer meeting. For each worker, the scheduler may determine an estimated arrival time based upon a plurality of time consuming events. The scheduler may instruct the worker with the lowest cumulative time consuming events to the next customer. For example, for each worker the time to the next customer can be the sum of 1) the time remaining to complete the current work, 2) the estimated drive time from the worker's current location to the next customer and 3) other time events: lunch/bathroom breaks, vehicle fuel level, etc. In some embodiments, the scheduler may weigh the different time factors differently. For example, if a worker is in close proximity to the next customer, the scheduler may assign this meeting to the closest worker rather than the next available worker who must drive a long distance to minimize the costs for fuel and vehicle wear. In order to adjust the calculation, the scheduler may use a driving factor which can be greater than 1 and variable depending upon the price of gas and cost of vehicle maintenance. This calculation can be represented by the following algorithm: Worker Selection Score=TIME current job+(driving factor) TIME drive to next customer+TIME breaks/fuel.

Although the inventive system has been described for work service activities, in other embodiments, the inventive system can be used for various other applications. For example, a doctor's patient schedule can be managed with the inventive system. Patient's can be given appointment times and the doctor can see patients and make adjustments to the schedule throughout the day. These schedule updates can be transmitted to the patient's throughout the day as patients are seen. In an embodiment, the system may have a minimum schedule adjustment time that is required before notifications are sent to the patients. This process can minimize the wasted waiting time for patients and doctors.

A similar system can be used for restaurant reservations. Customers can make reservations for a specific time or indicate a preference for an earlier time. The system can transmit updates regarding the availability of tables to customers wishing an earlier seating based upon the estimated completion times for diners. Customers who wish to have a set seating time can be omitted from these updates. The system can provide an estimated time availability for a table which can be an estimated number of minutes which is transmitted to the mobile device of the customer. The customer can respond to this notice by pressing a button accepting the estimated time seating or declining. The declined offer can then be transmitted to another customer. By transmitting estimated time availabilities, the customer can perform any other activity and does not have to wait at the restaurant. In other embodiments, the inventive system can be used with various other applications.

In an embodiment, the inventive system can be integrated into the company's computer system and the customers' electronic devices in various different ways. Schedulers 113, 114 can operate with company's calendar information to coordinate the scheduling. The schedulers 113, 114 can also transmit the customer information to the workers' mobile devices. The schedulers 113, 114 can also utilize GPS information from the workers and available traffic information.

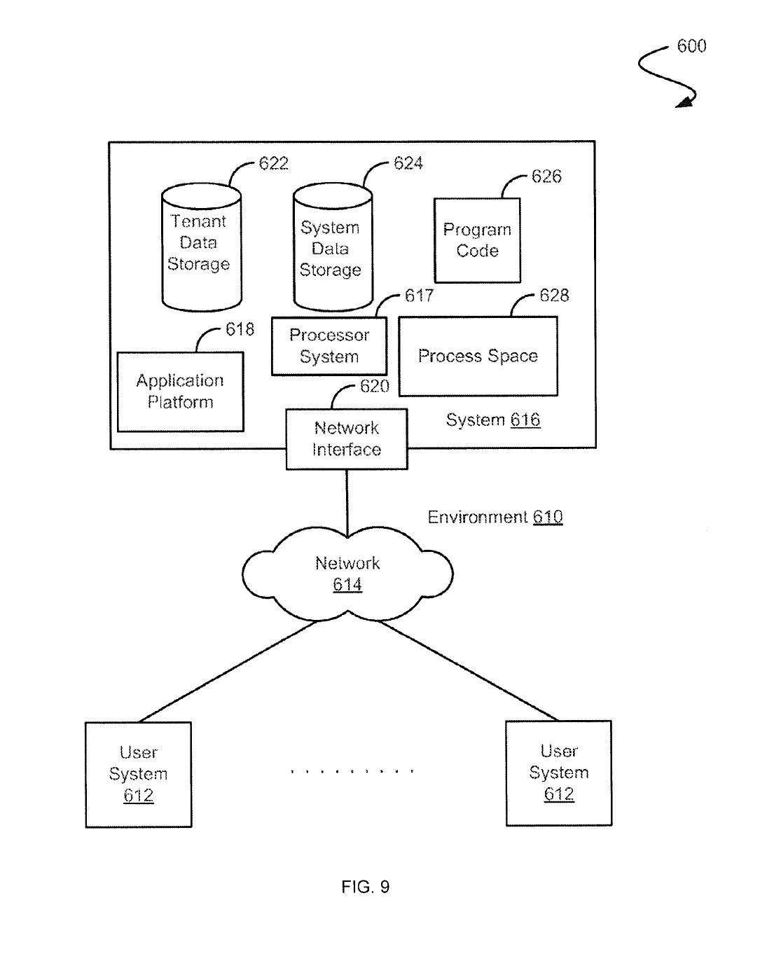

FIG. 9 illustrates a block diagram of an environment 610 wherein an on-demand database service might be used. Environment 610 may include user systems 612, network 614, system 616, processor system 617, application platform 18, network interface 620, tenant data storage 622, system data storage 624, program code 626, and process space 628. In other embodiments, environment 610 may not have all of the components listed and/or may have other elements instead of, or in addition to, those listed above.

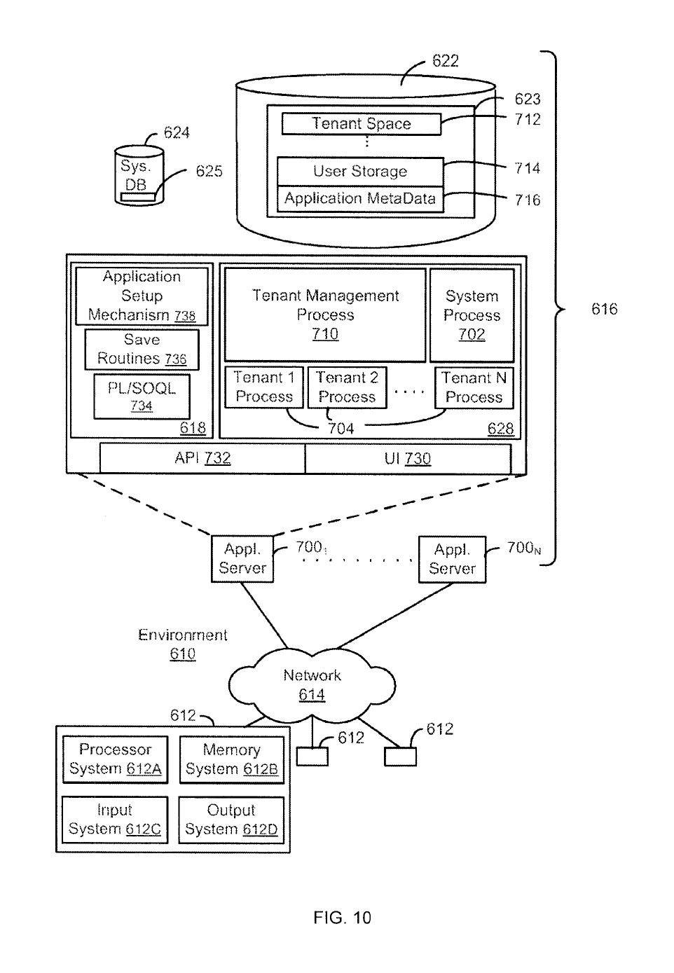

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 9 (and in more detail in FIG. 10) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 9, implements a web-based customer relationship management (CRM) system. For example, in one embodiment, system 616 includes application servers configured to implement and execute CRM software applications as well as provide related data, code, forms, web pages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 16 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 9, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 9 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 10 also illustrates environment 610. However, in FIG. 10 elements of system 616 and various interconnections in an embodiment are further illustrated. FIG. 10 shows that user system 612 may include processor system 612A, memory system 612B, input system 612C, and output system 612D. FIG. 10 shows network 614 and system 616. FIG. 10 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 10001-1000N, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 9. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 10, system 616 may include a network interface 620 (of FIG. 9) implemented as a set of HTTP application servers 700, an application platform 618, tenant data storage 622, and system data storage 624. Also shown is system process space 702, including individual tenant process spaces 704 and a tenant management process space 710. Each application server 1000 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example.

Invocations to such applications may be coded using PL/SOQL 34 that provides a programming language style interface extension to API 732. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method comprising:
receiving by a scheduler a current location of a mobile device of a worker;
calculating by the scheduler, a first estimated travel time from the current location of the worker to a first appointment;
transmitting by the scheduler to the mobile device of the worker, a description of a first appointment with a first customer and an estimate first duration for the first appointment; and
transmitting by the scheduler to an electronic device of the first customer, a message that includes an estimated arrival time of the worker to the first appointment based upon the first estimated travel time.

2. The method of claim 1 further comprising:
receiving by a scheduler a notification of completion of the first appointment;
calculating by the scheduler, a second estimated travel time from the current location of the worker to a second appointment;
transmitting by the scheduler to the mobile device of the worker, a description of a second appointment with a second customer and an estimate second duration for the second appointment; and
transmitting by the scheduler to an electronic device of the second customer, a message that includes an estimated arrival time of the worker to the second appointment based upon the second estimated travel time.

3. The method of claim 1 further comprising:
emitting by the mobile device of the worker, a notification that the first appointment has exceeded the estimated first duration;
inputting to the mobile device, additional time needed for the first appointment;
receiving by a scheduler a notification of the additional time needed for the first appointment;
calculating by the scheduler, a second estimated travel time from the current location of the worker to a second appointment; and
transmitting by the scheduler to an electronic device of the second customer, an update message that includes an estimated arrival time of the worker to the second appointment based upon the second estimated travel time and the additional time needed for the first appointment.

4. The method of claim 3 further comprising:
receiving by the scheduler a reschedule time for the second appointment; and
transmitting by the scheduler the reschedule time for the second appointment to the mobile device of the worker.

5. The method of claim 3 further comprising:
receiving by the scheduler a cancellation of the second appointment; and
transmitting by the scheduler the cancellation of the second appointment to the mobile device of the worker.

6. The method of claim 1 further comprising:
receiving by a scheduler a notification of traffic delays on a route to the first appointment; and
transmitting by the scheduler to the electronic device of the first customer, an update message that includes a revised estimated arrival time of the worker to the first appointment based upon the traffic delays.

7. The method of claim 1 further comprising:
receiving by a scheduler a notification additional time needed for the first appointment;
calculating by the scheduler, a second estimated travel time from the current location of the worker to a second appointment; and
transmitting by the scheduler to an electronic device of the second customer, a message that includes an estimated arrival time of the worker to the second appointment based upon the second estimated travel time and the additional time needed for the first appointment.

8. The method of claim 7 further comprising:
receiving by a scheduler a notification of completion of the first appointment; and
transmitting by the scheduler to the mobile device of the worker, a description of a second appointment with a second customer and an estimate second duration for the second appointment.

9. The method of claim 7 further comprising:
receiving by a scheduler a notification of traffic delays on a route to the second appointment; and
transmitting by the scheduler to the electronic device of the second customer, an update message that includes a revised estimated arrival time of the worker to the second appointment based upon the traffic delays.

10. The method of claim 9 further comprising:
receiving by the scheduler a reschedule time for the second appointment; and
transmitting by the scheduler the reschedule time for the second appointment to the mobile device of the worker.

11. A method comprising:
calculating by the scheduler, a first arrival time of a worker to a first appointment;
calculating by the scheduler, a second arrival time of the worker to a second appointment;
transmitting by the scheduler to the mobile device of the worker, a description of a first appointment with a first customer, an estimate first duration for the first appointment, a description of a second appointment with a second customer, an estimate second duration for the second appointment; and
transmitting by the scheduler to an electronic device of the first customer, a message that includes an estimated arrival time of the worker to the first appointment; and
transmitting by the scheduler to an electronic device of the second customer, a message that includes an estimated arrival time of the worker to the second appointment.

12. The method of claim 11 further comprising:
emitting by the mobile device of the worker, a notification that the first appointment has exceeded the estimated first duration;
inputting to the mobile device, additional time needed for the first appointment;
receiving by a scheduler a notification of the additional time needed for the first appointment;
calculating by the scheduler, a second estimated travel time from the current location of the worker to a second appointment; and
transmitting by the scheduler to an electronic device of the second customer, an update message that includes an estimated arrival time of the worker to the second appointment based upon the second estimated travel time and the additional time needed for the first appointment.

13. The method of claim 12 further comprising:
receiving by the scheduler a reschedule time for the second appointment; and
transmitting by the scheduler the reschedule time for the second appointment to the mobile device of the worker.

14. The method of claim 12 further comprising:
receiving by the scheduler a cancellation of the second appointment; and
transmitting by the scheduler the cancellation of the second appointment to the mobile device of the worker.

15. The method of claim 11 further comprising:
receiving by a scheduler a notification of traffic delays on a route to the first appointment; and
transmitting by the scheduler to the electronic device of the first customer, an update message that includes a revised estimated arrival time of the worker to the first appointment based upon the traffic delays.

16. The method of claim 11 further comprising:
receiving by a scheduler a notification additional time needed for the first appointment;
calculating by the scheduler, a second estimated travel time from the current location of the worker to a second appointment; and
transmitting by the scheduler to an electronic device of the second customer, a message that includes an estimated arrival time of the worker to the second appointment based upon the second estimated travel time and the additional time needed for the first appointment.

17. The method of claim 16 further comprising:
receiving by a scheduler a notification of completion of the first appointment; and
transmitting by the scheduler to the mobile device of the worker, a description of a second appointment with a second customer and an estimate second duration for the second appointment.

18. The method of claim 16 further comprising:
receiving by a scheduler a notification of traffic delays on a route to the second appointment; and
transmitting by the scheduler to the electronic device of the second customer, an update message that includes a revised estimated arrival time of the worker to the second appointment based upon the traffic delays.

19. The method of claim 18 further comprising:
receiving by the scheduler a reschedule time for the second appointment; and
transmitting by the scheduler the reschedule time for the second appointment to the mobile device of the worker.

20. The method of claim 18 further comprising:
receiving by the scheduler a cancellation of the second appointment; and
transmitting by the scheduler the cancellation of the second appointment to the mobile device of the worker.
